(19) United States
(12) Patent Application Publication
(10) Pub. No.: US 2013/0109563 A1
(43) Pub. Date: May 2, 2013

(54) PREPARING CERIUM(III) COMPOUNDS

(71) Applicant: BASF SE, Ludwigshafen (DE)

(72) Inventors: Nils Bottke, Mannheim (DE); Markus Schubert, Ludwigshafen (DE); Markus Ruf, Hassloch (DE); Christian Walsdorff, Ludwigshafen (DE)

(73) Assignee: BASF SE, Ludwigshafen (DE)

(21) Appl. No.: 13/661,706

(22) Filed: Oct. 26, 2012

Related U.S. Application Data
(60) Provisional application No. 61/553,265, filed on Oct. 31, 2011.

(51) Int. Cl. B01J 23/83; C22B 59/00; B01J 23/745

(52) U.S. Cl. 502/302; 502/305; 423/21.1

(57) ABSTRACT

The invention relates to a process for preparing cerium(III) compounds which comprises the steps of
a) contacting a starting composition A comprising cerium dioxide and at least one further metal oxide selected from the group consisting of iron oxide, silicon dioxide, molybdenum oxide, lanthanum oxide, magnesium oxide and calcium oxide with at least one acid S and at least one iron component E comprising iron in the oxidation state 0 and/or II at a temperature ranging from 40 to 160° C. and at a pH of not more than 2 to obtain a solution L comprising cerium in the oxidation state III;
b) adding at least one basic compound C to said solution L to obtain a solid F comprising at least one cerium(III) compound;
c) separating off said solid F comprising at least one cerium(III) compound.

The present invention relates to a process for preparing cerium(III) compounds, especially cerium(III) carbonate, starting from starting compositions comprising cerium dioxide and at least one further metal oxide.

Preferred starting compositions comprising cerium dioxide and at least one further metal oxide are more particularly compositions comprising a relatively high proportion of cerium dioxide, making cerium regeneration/recovery desirable. Starting compositions comprising cerium dioxide and at least one further metal oxide are for example dehydrogenation catalysts (for example catalysts for dehydrogenation of ethylbenzene) or waste products from grinding or polishing glass comprising cerium dioxide and usually silicon dioxide and/or lanthanum oxide.

The present invention further relates to a process for preparing a dehydrogenation catalyst comprising iron oxide and cerium dioxide, especially a dehydrogenation catalyst useful in styrene production (hereinafter also called dehydrogenation catalysts or styrene catalysts) starting from an abovementioned starting composition especially starting from spent styrene catalyst.

The production of styrene by heterogeneously catalyzed dehydrogenation of ethylbenzene in the presence of steam has been practiced on a large industrial scale since the early 1930s and has become the established route to styrene. Styrene is one of the oldest and most important starting materials for the production of plastics, e.g., polystyrene and synthetic rubber.

Generally, industrial production of styrene by dehydrogenation of ethylbenzene is practiced as an isothermal process or as an adiabatic process. The isothermal process for producing styrene is generally practiced in the gas phase at temperatures of 450 to 700° C. by addition of steam at a pressure of 0.1 to 2 bar, while thermal energy is supplied to the reactor from the outside in order that the reaction temperature may be kept approximately constant. The adiabatic process, by contrast, generally involves pressures from 0.2 to 1 bar as well as temperatures of 450 to 700° C., while the thermal energy needed for the reaction is supplied via superheated steam at the start of the reaction and the temperature in the reactor decreases during the endothermic reaction.

Ethylbenzene dehydrogenation catalysts used in both the adiabatic process and the isothermal process are generally multicomponent systems and comprise essentially iron oxide and one or more alkali metal compounds which are used as alkali metal oxides, carbonates or hydroxides, for example, to prepare the catalyst. These catalysts further typically comprise various further active components which are known as promoters; compounds of calcium, magnesium, cerium, molybdenum, tungsten, chromium and titanium for example have been described as promoters in the prior art. The promoters which are actually in common use are oxides of elements of transition groups 5 and 6 of the periodic table and of rare earths, for example oxides of cerium and of molybdenum (U.S. Pat. No. 3,904,552) or oxides of cerium and of vanadium (DE-A 28 15 812).

Numerous processes for preparing dehydrogenation catalysts on the basis of iron oxide are described in the prior art. EP-A 0 181 999 describes a dehydrogenation catalyst which in addition to iron oxide (Fe₂O₃), potassium oxide (K₂O) and magnesium oxide (MgO) may further comprise a compound of cerium, of molybdenum or of tungsten.

Various natural and synthetic iron oxides, such as α-Fe₂O₃ (hematite), γ-Fe₂O₃, iron oxide hydroxide (e.g., α-FeOOH), Fe₃O₄ (magnetite) and iron oxides obtainable by thermal decomposition of iron salt solutions are described in the prior art as useful iron oxide component in the preparation of dehydrogenation catalysts. The cerium compound used in the preparation of dehydrogenation catalysts is frequently cerium(III) oxide (Ce₂O₃), cerium(III) oxalate or cerium(III) carbonate, and is normally converted into cerium dioxide in the course of catalyst preparation.

A dehydrogenation catalyst is generally prepared by mixing the components with or without addition of a binder and then forming a catalyst from the mixture (by extrusion for example) and subsequently calcining the formed catalyst at temperatures in the range from 500 to 1200° C.

Coking in the catalytic dehydrogenation of ethylbenzene to styrene typically causes blocking of the active sites of the dehydrogenation catalyst in the course of the production process and gradual deactivation of the catalyst. To reduce this deactivation, steam is added to the ethylbenzene. Spent (i.e., deactivated) catalysts are generally removed from the reactor and sent for disposal.

There are no processes in the prior art whereby spent, i.e., deactivated, catalysts can be fully regenerated or valuable materials, such as cerium for example, recovered from the spent catalyst.

In view of iron oxide-based styrene catalyst consumption amounting to about 8000 metric tons a year and rising raw-material costs for heavy metals, there is an immense need for a simple, sustainable and economical process for regenerating spent styrene catalyst and/or for recovering cerium from spent catalysts.

Waste products from grinding or polishing glass are further starting compositions for obtaining/recovering cerium. Ceria-based grinding and polishing agents (also called opalines) are widely used in the optical industry for working industrial and decorative glasses. Glass polishes based on ceria and their methods of making are described for example in WO 2007/009145 and U.S. Pat. No. 4,769,073. Polishing glasses typically with an aqueous suspension comprising ceria and usually further metal oxides (lanthanum oxide for example) generates aqueous grinding wastes which normally further comprise small fractions of abraded-off silicon dioxide and generally are disposed of. These grinding wastes can constitute a starting material for obtaining cerium(III) compounds.

The present invention has for its object to provide a simple and inexpensively realized process for recovering cerium from starting compositions comprising cerium dioxide and at least one further metal oxide, especially from spent dehydrogenation catalysts and/or grinding agent wastes. The present invention further has for its object to provide a simple, inexpensive and sustainable process for regenerating spent dehydrogenation catalysts comprising cerium dioxide and at least one further metal oxide.

It has now been found that the process of the present invention provides a way whereby cerium dioxide is simply and quantitatively brought into solution in strong acids in its trivalent form in the presence of iron in the oxidation state 0 and/or II and separated from concomitants.

The present invention relates to a process for preparing cerium(III) compounds and especially cerium(III) carbonate comprising the steps of
a) contacting a starting composition A comprising cerium dioxide and at least one further metal oxide selected from the group consisting of iron oxide (e.g., Fe₂O₃), silicon dioxide (SiO₂), molybdenum oxide (e.g., MoO₃), lanthanum oxide (La₂O₃), magnesium oxide (MgO) and calcium oxide (CaO) with at least one acid S and at least one iron component E comprising iron in the oxidation state 0 and/or II at a temperature ranging from 40 to 160° C., preferably from 40 to 120° C. and more preferably from 60 to 160° C. and at a pH of not more than 2 and preferably in the range from −2 to 2 to obtain a solution L comprising cerium in the oxidation state III;
b) adding at least one basic compound C to said solution L to obtain a solid F comprising at least one cerium(III) compound and especially cerium(III) carbonate;
c) separating off said solid F comprising at least one cerium(III) compound,

The process of the present invention thus provides a simple and inexpensive process for obtaining/recovering cerium(III) compounds which is notable for inexpensive starting materials, a low number of needed process steps and simple implementation (apparatus requirements are minimal) of individual process steps.

The process of the present invention similarly provides a good ranging to almost complete yield of cerium and also the almost complete removal of undesired concomitants. The cerium(III) compound obtained using the process of the present invention, especially cerium(III) carbonate, is notable for high purity and particularly a low proportion of nitrate ions and also low admixture of other lanthanides such as praseodymium and/or neodymium. The cerium(III) compound obtained using the process of the present invention can be further converted for example into cerium dioxide (CeO₂) which is notable for high whiteness. Existing processes for obtaining cerium dioxide are problematic in that admixtures of praseodymium and/or neodymium frequently lead to a disadvantageous reddish to dark brown discoloration of the cerium dioxide.

Furthermore, the solid obtained using the process of the present invention as comprising at least one cerium(III) compound and especially cerium(III) carbonate is suitable for direct further processing into a dehydrogenation catalyst (styrene catalyst for example). The process which the present invention provides for preparing a dehydrogenation catalyst thus makes possible a sustainable process for preparing styrene catalysts or for regenerating spent, deactivated styrene catalysts.

One preferred embodiment comprises utilizing a starting composition A comprising a solid comprising cerium dioxide, at least one iron oxide and at least one alkali metal oxide. More particularly, starting composition A comprises at least one dehydrogenation catalyst comprising cerium dioxide and at least one iron oxide and used and/or usable for the catalytic dehydrogenation of ethylbenzene. More particularly, starting composition A is a spent styrene catalyst removed from a plant for catalytic dehydrogenation of ethylbenzene. Examples of known dehydrogenation catalysts include catalysts of the Styrostar® range (from BASF), catalysts of the Hypercat® and Flexikat® ranges (from CRI) and also catalysts of the Styromax® range (Süd-Chemie).

Starting composition A may typically comprise:
50 to 88 wt %, preferably 63 to 78 wt % of at least one iron oxide, especially Fe₂O₃;
7 to 14 wt %, preferably 9 to 14 wt % of at least one alkali metal compound, preferably a potassium compound and more preferably potassium oxide (K₂O);
5 to 11 wt %, preferably 6 to 10 wt % of cerium dioxide;
0 to 5 wt %, preferably 0.5 to 4 wt % and more preferably 1.5 to 2.5 wt % of further metal oxides.

The above particulars in wt % are all based on the total amount of starting composition A and are reckoned on the basis of the particular oxide and/or the oxide which is stablest under standard conditions. It is typically possible for starting composition A to comprise in part mixed phases of the oxides mentioned.

Typically, starting composition A comprises at least one iron oxide selected from iron oxides normally used in dehydrogenation catalysts and/or formed in the use of dehydrogenation catalysts, more particularly selected from the group consisting of α-Fe₂O₃ (hematite), γ-Fe₂O₃, iron oxide hydroxide (α-FeOOH), Fe₃O₄ (magnetite) and synthetic iron oxides prepared from iron salt solutions.

A further embodiment of the invention utilizes an aqueous suspension comprising cerium dioxide and silicon dioxide as starting composition A. More particularly, starting composition A comprises at least one waste product from grinding or polishing glass comprising cerium dioxide and at least silicon dioxide (SiO₂) and optionally lanthanum oxide (La₂O₃).

Composition A may typically comprise:
30 to 99 wt %, preferably 63 to 78 wt % of cerium dioxide;
0 to 25 wt %, preferably 5 to 25 wt % and more preferably 10 to 20 wt % of at least one lanthanum compound, especially lanthanum oxide (e.g., La₂O₃);
0.1 to 10 wt %, preferably 0.5 to 5 wt % of silicon dioxide (SiO₂),
0 to 2 wt %, preferably 0.1 to 1 wt % of at least one further compound of metals selected from aluminum, potassium, calcium, titanium, strontium and zirconium, more particularly selected from oxides of the metals mentioned.

The above particulars in wt % are all based on the total amount of starting composition A and are reckoned on the basis of the particular oxide and/or the oxide stablest under standard conditions.

Starting composition A can also be an aqueous suspension of components mentioned above. Typically, the aqueous suspension has a density ranging from 1 to 1.5 kg/l and/or a solids content of 5 to 30 wt % and especially 10 to 20 wt %. Starting composition A may optionally be dried before step a. It is further conceivable for starting composition A to be pretreated—by ignition for example—before step a in order to remove organic impurities.

Typically, the at least one acid S can be selected from strong or very strong organic or inorganic acids known to a person skilled in the art. A strong or very strong acid is more particularly an acid having a pKₐ value of not more than 4. The at least one acid S is preferably hydrochloric acid and/or sulfuric acid.

The iron component E can be added in solid form, for instance as iron powder, or in the form of iron(II) salt solutions. The at least one iron component E is preferably selected from the group consisting of elemental iron, iron alloy, steel (e.g., steel shavings), steel alloy, iron(II) chloride, iron(II) carbonate, iron(II) sulfate and iron(II) ammoniumsulfate. One embodiment of the invention utilizes scrap iron (chipped scrapped iron for example) as iron component E.

Typically, at least one iron compound E comprising iron in the oxidation state 0 and/or II is added in order that the cerium(IV) present may be converted into the soluble cerium(III) form. Preferably, the at least one iron component E is used in an amount of 0.5 to 10 mol/mol, preferably from 0.5 to 2 mol/mol and more preferably 0.8 to 1.2 mol/mol based on amount of substance of iron to amounts of substance of cerium in starting composition A. It is particularly preferable to use iron component E in a stoichiometric proportion based on amount of substance of iron to amounts of substance of cerium in starting composition A.

Adding an iron component comprising iron in the oxidation state 0 may typically give rise to the evolution of hydrogen gas and foaming of the mixture (comprising starting composition A, iron component E and acid S). This embodiment may more particularly comprise suitable engineering measures to remove the hydrogen gas. It is similarly possible to add defoamers (for example defoamers based on silicone oil or polydimethylsiloxane defoamers) to the mixture (comprising starting composition A, iron component E and acid S).

More particularly, the at least one basic compound C is selected from the group consisting of alkali metal carbonate, alkali metal bicarbonate, alkaline earth metal carbonate, alkaline earth metal bicarbonate, alkali metal hydroxide and alkaline earth metal hydroxide, preferably consisting of sodium carbonate, sodium bicarbonate, potassium carbonate, calcium carbonate, magnesium carbonate, sodium hydroxide, calcium hydroxide, more preferably sodium carbonate and sodium hydroxide and even more preferably sodium carbonate (e.g., soda Na₂CO₃.10 H₂O).

Basic compound C preferably comprises at least one carbonate compound selected from the group consisting of alkali metal carbonate, alkali metal bicarbonate, alkaline earth metal carbonate and alkaline earth metal bicarbonate, preferably from the group consisting of sodium carbonate, sodium bicarbonate, potassium carbonate, calcium carbonate and magnesium carbonate.

In one preferred embodiment of the process described, starting composition A comprising cerium dioxide and at least one further metal oxide is comminuted to particle sizes having a median particle diameter (D₅₀) ranging from 50 to 500 μm and especially from 50 to 200 μm before step a. This can typically be effected using known processes and apparatus, for example by milling.

For the purposes of the present invention, the median particle diameter (D₅₀) indicates the equivalent diameter of corpuscles approximated as spherical shape, with 50% (volume percent based on the entire sample) of corpuscles having a diameter below the D₅₀ value and 50% (volume percent based on the entire sample) having a value above the D₅₀ value. The median particle diameter (D₅₀) can be determined using laser diffraction for example.

In one embodiment of the process described, starting composition A comprising cerium dioxide and at least one further metal oxide is contacted with at least one acid S at temperatures ranging from 0 to 100° C., preferably from 0 to 50° C., more preferably from 0 to 35° C. and even more preferably from 20 to 35° C. and preferably at a pH ranging from 1 to 3 and especially from 1 to 2 before step a and the solution obtained (aqueous phase) is separated off. The insoluble residue obtained is typically separated off and optionally washed and/or optionally dried. Typically, the insoluble residue obtained is used as starting composition A in the further steps. This pretreatment with at least one acid S can serve for example to wash off lanthanum oxide and/or molybdenum oxide. Lanthanum dioxide and/or molybdenum oxide can constitute an important raw material, and so the oxides mentioned may optionally be isolated from the solution obtained (aqueous phase) and revalorized.

In one embodiment of the process described, starting composition A comprising cerium dioxide and at least one further metal oxide is treated before step a in order that organic impurities may be separated off. This is more particularly effected by ignition (burn-off of organic residues) of starting composition A in air or lean air at temperatures ranging from 400 to 1000° C. and preferably from 550 to 850° C. The solid residue obtained is typically used as starting composition A in the further steps.

Step a of the process according to the present invention comprises contacting a starting composition A comprising cerium dioxide and at least one further metal oxide with at least one acid S and at least one iron component E comprising iron in the oxidation state 0 and/or II at a temperature ranging from 40 to 160° C. and a pH of not more than 2 to obtain a solution L comprising cerium in the oxidation state III.

The contacting temperature in step a is preferably in the range from 40 to 160° C., more preferably in the range from 40 to 120° C., even more preferably in the range from 60 to 120° C. and more particularly in the range from 90 to 120° C. More particularly, the contacting in step a is effected at or close to the boiling point of the mixture (comprising starting composition A, iron component E and acid S). More particularly, the contacting in step a is effected at the boiling point under reflux. Step a of the process typically comprises the addition of starting composition A to at least one acid S and adding at least one iron component E and heating this mixture to the boil. The temperature of the mixture (comprising starting composition A, iron component E and acid S) is preferably maintained at the appropriate temperature/the boiling point for 10 minutes to 8 hours, preferably from 1 to 4 hours and more preferably from 0.5 to 2 hours.

The contacting in step a is preferable at a pH ranging from −2 to 2 and more preferable from −1 to 1. The contacting in step a) is typical at pressures ranging from 0.7 to 4 bar, preferably from 0.7 to 1.2 bar and more particularly at atmospheric pressure (about 1 bar).

Step a of the process according to the present invention typically provides a solution L comprising cerium in the oxidation state III and more particularly converts the entire cerium in the starting composition into the oxidation state III.

In one embodiment of the process, a solid F1 is obtainable in step a as well as said solution L comprising cerium in the oxidation state III. This solid F1 may comprise silicon dioxide and/or molybdenum oxide in particular. Solution L obtained in step a may optionally be separated from the insoluble solid F1.

Step b) of the process according to the present invention comprises adding at least one basic compound C to solution L to obtain a solid F comprising at least one cerium(III) compound. For the purposes of the present invention, solid F comprising at least one cerium(III) compound is more particularly formed by precipitation due to reduced solubilities at the given conditions. A person skilled in the art knows that solution equilibria are always concerned even in connection with very sparingly soluble or virtually insoluble compounds.

In one preferred embodiment of the invention, the adding of at least one basic compound C in step b) provides a pH ranging from 6 to 12 and preferably from 7 to 9.

In a further preferred embodiment; adding the at least one basic compound is done stepwise by setting various pH levels with optional removal of the possibly resulting solid (solid phases) (fractional precipitation). Adding a basic compound and removing solid obtained can typically be done in 1 to 10 steps and preferably in 1 to 3 steps, in which case identical or different abovementioned basic compounds can be selected for every step.

In one embodiment, step b comprises the steps of:
adding at least one basic compound C to said solution L until a pH ranging from 2.5 to 5, more particularly from 3 to 5 and more particularly from 4.5 to 5 is obtained to obtain a solid F2 comprising at least one iron compound;
separating said solid F2 from said solution L;
adding at least one basic compound C to said solution L until a pH ranging from 6 to 12 and especially from 7 to 9 is obtained to obtain a solid F comprising at least one cerium(III) compound.

The temperature for adding at least one basic compound C to solution L in step b is preferably in the range from 0 to 120° C., more particularly from 10 to 80° C., and more particularly from 10 to 60° C. The temperature in step b can typically be lowered to temperatures ranging from 0 to 30° C. in order that precipitation of cerium(III) compound(s) may be as complete as possible.

Adding at least one basic compound C to solution L in step b is typically done at pressures ranging from 0.7 to 1.2 bar and more particularly at atmospheric pressure (about 1 bar).

Step c of the process according to the present invention comprises separating off solid F comprising at least one cerium(III) compound and especially cerium(III) carbonate. Solid F comprising at least one cerium(III) compound may more particularly comprise at least one iron compound, for example iron oxide, iron oxide hydroxide, iron hydroxide, as further constituent.

For the purposes of the present invention, separating off solid. F comprises more particularly separating the solid phase (solid F) from the liquid phase (solution L). Separating off solid F in step c may typically be effected using known separation processes and apparatus in that, for example, step c may comprise a step selected from filtering, centrifuging, sedimenting, decanting and membrane filtration. Separating off solid F may be augmented by applying negative pressure for example.

Separating off solid F in step c is typically done at temperatures ranging from 0 to 100° C. and especially from 10 to 50° C. Separating off solid F in step c is more particularly done at pressures ranging from 0.7 to 1.2 bar and more particularly at atmospheric pressure (about 1 bar).

The described process step for separating off solid F may also be applied mutatis mutandis for separating off further optionally obtained solids (e.g., F1, F2).

In one embodiment of the process, solid F obtained in step c as comprising at least one cerium(III) compound is subjected to washing and/or drying. More particularly, solid F obtained in step c is washed with a washing agent, especially water. Solid F is preferably washed until a level of acid anions (such as chloride and sulfate anions) of below 3000 ppm, preferably below 1000 ppm, more preferably of less than 500 ppm and even more preferably of less than 200 ppm (based on dry substance of solid F) is achieved in solid F. It is particularly preferable for solid F to comprise less than 200 ppm, preferably less than 50 ppm and more preferably less than 10 ppm (based on dry substance of solid F) of anions.

The expression “ppm” for the purposes of the present invention signifies mg/kg (milligram per kilogram).

When the process for preparing cerium(III) compounds relates to the use of at least one waste product from grinding or polishing glass as starting composition A, it may comprise more particularly the steps of:
i) optionally drying said starting composition A;
ii) optionally igniting (burning off organic residues) said starting composition A in an air or lean air atmosphere at temperatures ranging from 400 to 1000° C. and preferably from 550 to 850° C., wherein the solid residue obtained is used as starting composition A in the further steps;
iii) optionally contacting said starting composition A with at least one acid S at temperatures ranging from 0 to 100° C., preferably from 0 to 50° C., preferably from 0 to 35° C. and more preferably from 20 to 35° C. and preferably at a pH ranging from 1 to 3 and especially from 1 to 2 and separating off the solution obtained, wherein the insoluble residue obtained is used as starting composition A in the further steps;
iv) contacting said starting composition A with at least one acid S and at least one iron component E comprising iron in the oxidation state 0 and/or II at a temperature ranging from 40 to 160° C. and a pH of not more than 2 and preferably ranging from −2 to 2 to obtain a solution L comprising cerium in the oxidation state III and optionally a solid F1;
v) optionally separating off said solid F1;
vi) adding at least one basic compound C to said solution L to obtain a solid F comprising at least one cerium(III) compound;
vii) separating off said solid F comprising at least one cerium(III) compound;
viii) optionally washing and/or drying said solid F.

The present invention further provides a process for preparing a dehydrogenation catalyst comprising at least one iron oxide and at least one cerium(IV) compound comprising the preparation of a cerium(III) compound (or of a solid F comprising at least one cerium(III) compound) as described above and also the steps of:
d) mixing said solid F comprising at least one cerium(III) compound with at least one further component and optionally water to obtain a catalyst composition K;
e) molding said catalyst composition K;
f) calcining said catalyst composition K to obtain a dehydrogenation catalyst comprising at least one iron oxide (especially Fe₂O₃) and at least one cerium(IV) compound (especially cerium dioxide).

The process which the present invention provides for preparing a dehydrogenation catalyst thus provides a simple, inexpensive and sustainable process for preparing/regenerating dehydrogenation catalysts, especially styrene catalysts, which is notable for inexpensive starting materials, for a low number of needed process steps and for simple implementation (equipment requirements are minimal) of individual process steps.

Dehydrogenation catalysts obtained using the process of the present invention display equivalent or improved activity, selectivity and/or stability as compared with commercially used fresh catalysts. The process which the present invention provides for preparing a dehydrogenation catalyst is particularly notable in that relatively low calcination temperatures are needed to obtain stable (especially to superheated steam) catalysts having good activity and selectivity. Particularly advantageous properties are obtainable for the dehydrogenation catalyst when the cerium and iron compounds were precipitated at least partly together by adding a basic compound and thus exhibit particularly good (homogeneous) mixing. Catalysts obtained according to the present invention are especially useful for the dehydrogenation of ethylbenzene to styrene in all existing processes and process variants. They are particularly suitable for use in the so-called isothermal process.

The dehydrogenation catalysts obtained according to the present invention are typically notable for a low level of anions, especially chloride, nitrate and/or sulfate ions. The level of chloride, nitrate and/or sulfate ions in the dehydrogenation catalysts is preferably less than 3000 ppm, more preferably less than 1000 ppm, even more preferably less than 500 ppm and most preferably less than 200 ppm (based on the dehydrogenation catalyst or the dry substance of dehydrogenation catalyst).

In one preferred embodiment, the process for preparing a dehydrogenation catalyst is directed to a process for regenerating a spent dehydrogenation catalyst, i.e., where a spent dehydrogenation catalyst is used as starting composition A and a solid (F) comprising at least one cerium(III) compound and at least one iron compound is obtained, i.e., the cerium(III) is precipitated together with a proportion of iron.

The invention more particularly provides a process for preparing a dehydrogenation catalyst comprising at least one iron oxide and at least one cerium(IV) compound comprising the steps of:
a) contacting a starting composition A comprising cerium dioxide and at least one iron oxide with at least one acid S and at least one iron component E comprising iron in the oxidation state 0 and/or II at a temperature ranging from 40 to 160° C. and a pH of not more than 2 and preferably ranging from −2 to 2 to obtain a solution L comprising cerium in the oxidation state III;
b) adding at least one basic compound C, preferably at least one carbonate compound, to said solution L to obtain a solid F comprising at least one cerium(III) compound and at least one iron compound (especially iron(II) hydroxide, iron(III) hydroxide and/or iron carbonate);
c) separating off and optionally washing and/or optionally drying said solid F;
d) mixing said solid F with at least one further component selected especially from potassium oxide, iron oxide, magnesium oxide, calcium oxide, molybdenum oxide, potassium molybdate, tungsten oxide, potassium tungstenate, cobalt oxide (e.g., Co₂O₃), chromium oxide (Cr₂O₃), copper oxide (CuO), nickel oxide (NiO), titanium dioxide (TiO₂), silicon dioxide (SiO₂), aluminum oxide (Al₂O₃), sodium oxide (Na₂O), zinc oxide (ZnO), tin dioxide (SnO₂), silver oxide (Ag₂O) and rhenium oxide (Re₂O₇) and optionally water to obtain a catalyst composition K;
e) molding said catalyst composition K;
f) calcining said catalyst composition K to obtain a dehydrogenation catalyst comprising at least one iron oxide (especially Fe₂O₃) and at least one cerium(IV) compound (especially cerium dioxide).

Steps a to c of the process for preparing a dehydrogenation catalyst may be embodied mutatis mutandis in line with the embodiments described above in connection with the process for preparing a cerium(III) compound. Dehydrogenation catalyst comprising at least one iron oxide (especially Fe₂O₃) and at least one cerium(IV) compound (especially cerium dioxide) for the purposes of the present invention is to be understood as meaning that the corresponding metals can be determined in the catalyst in the amounts stated where applicable. The catalyst may typically comprise mixed phases and/or isolated phases of the metal oxides mentioned.

The preparation of styrene catalysts typically comprises:
providing and mixing the components;
molding, for example extruding or pressing;
and calcining the moldings.

The process for preparing a dehydrogenation catalyst may further comprise pressing and/or drying the moldings.

Typically, a water-containing solid F comprising at least one cerium(III) compound and at least one iron compound is mixed with at least one further component, especially with at least one further active component (dopant). The further active component added may more particularly be at least one compound selected from the group consisting of iron compounds (especially oxides, e.g., Fe₂O₃), alkali metal compounds (especially oxides, e.g., potassium oxide), alkaline earth metal compounds (especially oxides, e.g., magnesium oxide, calcium oxide), chromium compounds (especially oxides, e.g., Cr₂O₃) and compounds (especially oxides) of elements of transition group 4 to 8 of the periodic table and of the lanthanides. Active components used can be compounds as present in the final catalyst or compounds that convert into compounds as present in the final catalyst during the method of making.

In one preferred embodiment, solid F is mixed with at least one iron oxide selected from natural and synthetic iron oxides (e.g., α-Fe₂O₃ (hematite), γ-Fe₂O₃, iron oxide hydroxide (e.g., α-FeOOH), Fe₃O₄ (magnetite) and iron oxides obtainable by thermal decomposition of iron salt solutions), potassium oxide and optionally further components to obtain a catalyst composition K.

It is preferable for the following compounds to be added in the stated amounts as further component:
7 to 14 wt %, preferably 9 to 14 wt % of at least one alkali metal compound, preferably a potassium compound and more preferably potassium oxide (K₂O);
0 to 4 wt %, preferably 0.5 to 4 wt % and more preferably 1.5 to 2.5 wt % of at least one active component selected from the group consisting of iron oxides, alkali metal oxides, alkaline earth metal oxides, chromium oxides and oxides of elements of transition group 4 to 8 of the periodic table and of the lanthanides.

The particulars in wt % are based on the proportion of the component in the final dehydrogenation catalyst and are reckoned on the basis of the particular oxide or the oxide stablest under standard conditions.

Addable further components also include auxiliaries to improve the processability, the mechanical strength or the pore structure. Useful further auxiliaries include for example binders, extrusion aids and porosity-improvers. Examples of aids are typically starch (potato starch for example), alginates, cellulose, methylcellulose, stearic acid, graphite and Portland cement.

The components are typically mixed intimately in the form of an aqueous paste directly in a mixer, kneader or preferably a Mix-Muller. They can also be slurried up into a sprayable slurry and processed in a spray dryer into a spray-dried powder. The components are preferably intimately mixed in a Mix-Muller or kneader in the presence of water to form an extrudable mass. Typically, the extrudable mass is subsequently extruded, dried and calcined. Drying temperatures are typically in the range from 60 to 400° C.

Preferred extrudates are from 2 to 10 mm and preferably from 2 to 6 mm in diameter. Extrudate cross section can be round or some other shape. Particular preference is given to extrudates of rotationally symmetrical cross section and also extrudates of star-shaped or those of toothed-wheel cross section. As an alternative to extrusion, catalysts can also be molded by tableting. Molding diameter is typically in the range from 2 to 10 mm and preferably in the range from 2 to 6 mm.

Calcining temperatures for the moldings are preferably in the range from 500 to 1100° C. and especially in the range from 800 to 950° C.

The preparation of a dehydrogenation catalyst is described for example in EP 0 181 999 and EP 0 502 510.

The present invention further provides a composition comprising at least one cerium(III) compound (solid F) obtainable by the process described above. More particularly, the composition of the present invention is solid F comprising at least one cerium(III) compound and obtainable as described above.

The present invention more particularly provides a composition comprising
at least 20 wt % based on the entire composition of at least one cerium(III) compound, especially cerium(III) carbonate;
0 to 80 wt % based on the total weight of the rare earth metal oxides of at least one iron compound, and
0 to 50 ppm based on the entire composition of nitrate.

The above particulars in wt % or ppm are each based on the metal oxides or the oxides stablest under standard conditions.

The compositions of the present invention comprise at least one cerium(III) compound, especially cerium(III) carbonate, typically have a loss on ignition (especially due to evolution of carbon dioxide and/or water) of 40 to 60 wt %. It is therefore customary to relate the content of metal components to the ignited mass or to the total weight of the rare earth metal compounds (rare earth metal oxides) and to use in each case the masses of the particular oxides. The level of anions (nitrate for example) is typically determined from the composition and therefore typically reported as based on the weight of the overall composition or the dry weight of the overall composition.

The composition provided by the present invention as comprising at least one cerium(III) compound, especially cerium(III) carbonate, is notable in comparison with commercially available compositions for having a low proportion of nitrate (preferably less than 50 ppm and more preferably less than 10 ppm based on the entire composition).

The compositions of the present invention may further be notable for a low proportion of other rare earth metal compounds, especially other lanthanide compounds, as well as cerium. The level of other rare earth metal compounds, especially other lanthanide compounds, besides cerium, such as for example lanthanum oxide (La₂O₃), praseodymium oxide (Pr₆O₁₁) and neodymium oxide (Nd₂O₃), may be more particularly less than 10 000 ppm, preferably less than 5000 ppm and more preferably less than 100 ppm based on the total weight of the rare earth metal oxides.

The term “metals of the rare earth” or “rare earth metals” comprises the periodic table transition group III elements scandium (Sc) and yttrium (Y) and also lanthanum (La) and the 14 elements in the periodic table after lanthanum. The term “lanthanides” comprises lanthanum (La) and also the 14 elements in the periodic table after lanthanum.

In one preferred embodiment, the composition described above comprises from 0 to 2 wt % and preferably from 0.1 to 2 wt % based on the total weight of the rare earth metal oxides of molybdenum oxide (e.g., MoO₃).

In one embodiment of the invention, the composition described above comprises from 75 to 1000 ppm, preferably from 100 to 1000 ppm and more preferably from 200 to 1000 ppm based on the total weight of the rare earth metal oxides of at least one iron compound, especially at least one iron oxide (e.g., Fe₂O₃, Fe₃O₄). This typically holds for compositions obtainable by an above-described process wherein step b comprises adding at least one basic compound C stepwise and with removal of iron-containing solid.

The composition of the present invention typically comprises:
at least 20 wt % based on the entire composition of at least one cerium(III) compound, especially cerium(III) carbonate;
at least 50 ppm, especially at least 75 ppm, preferably at least 100 ppm and more preferably at least 200 ppm based on the total weight of the rare earth metal oxides of at least one iron compound, especially at least one iron oxide (e.g., Fe₂O₃, Fe₃O₄);
and 0 to 50 ppm, preferably 0 to 10 ppm based on the entire composition of nitrate.

The above particulars in wt % or ppm are each based on the oxides or the oxides stablest under standard conditions.

In a further embodiment of the invention, the composition described above comprises from 30 to 80 wt %, preferably from 30 to 70 wt % and more preferably from 30 to 55 wt% based on the total weight of the rare earth metal oxides of at least one iron compound, especially at least one iron oxide (e.g., Fe₂O₃, Fe₃O₄). This typically holds for compositions obtainable by an above-described process wherein step b comprises a conjoint precipitation of cerium(III) compounds and iron compound. These compositions of high iron content are particularly useful for preparing a dehydrogenation catalyst.

The composition of the present invention typically comprises
at least 20 wt % based on the entire composition of at least one cerium(III) compound, especially cerium(III) carbonate;
30 to 80 wt %, preferably 30 to 70 wt % and more preferably 35 to 55 wt %, based on the total weight of the rare earth metal oxides of at least one iron compound, especially at least one iron oxide (e.g., Fe₂O₃, Fe₃O₄);
0 to 50 ppm, preferably 0 to 10 ppm based on the entire composition of nitrate.

The above particulars in wt % or ppm are based on the respective metal oxides or the oxides stablest under standard conditions.

The present invention further provides for the use of a cerium(III) compound, especially cerium(III) carbonate, obtainable by a process as described above for preparing a dehydrogenation catalyst comprising at least one iron oxide and at least one cerium(IV) compound.

The invention provides more particularly for the use of an above-described composition (or of a solid comprising at least one cerium(III) compound) for preparing a dehydrogenation catalyst comprising at least one iron oxide and at least one cerium(IV) compound.

The present invention further provides a process for catalytic dehydrogenation of ethylbenzene to styrene wherein the dehydrogenation is carried out in the presence of a catalyst obtainable by a process as described above. The present invention more particularly provides a process for catalytic dehydrogenation of ethylbenzene to styrene at temperatures of 450 to 700° C. and a pressure of 0.1 to 5 bar.

Exemplary embodiments of the present invention will now be more particularly described.

### EXAMPLE 1

### Dissolving of Cerium Dioxide

A 5 g quantity of cerium dioxide (of the HSA type from Rhodia) is weighed into a 250 ml glass beaker. After 80 ml of completely ion-free water (CIF water) (devolatilized) and 20 ml of concentrated hydrochloric acid (HCl, conc.) have been added the mixture is heated to about 100° C. under reflux and under agitation on a magnetic stirrer and stirred at 100° C. for 15 min. Mixture pH is −0.7. A nontransparent suspension forms in the process. Thereafter, 2 g of finely pulverized iron are added a little at a time. The mixture is stirred at about 100° C. for a further 10 min. A clear yellow solution forms within a short time.

### EXAMPLE 2

### Dissolving of Dehydrogenation Catalyst

The dehydrogenation catalyst used is an ethylbenzene dehydrogenation catalyst (hereinafter also called styrene catalyst) (Styrostar®, BASF) which is characterized as follows:

5 to 11 wt % of CeO₂, 7 to 14 wt % of K₂O, at least 50 wt % of Fe₂O₃, 0.5-4 wt % of further metal oxides. The particulars are based on the entire weight of the ignited catalyst. The CeO₂ content of the styrene catalyst is analytically determined using Inductively-Coupled Plasma Optical Emission Spectrometry (ICP-OES) after prior fusion or microwave digestion. The CeO₂ content of the styrene catalyst used is typically almost 10 wt %.

A 5 g quantity of milled styrene catalyst and 0.16 g of finely pulverized iron powder are weighed into a 250 ml glass beaker. After 80 ml of completely ion-free water (CIF water) (devolatilized) and 20 ml of concentrated hydrochloric acid (HCl, conc.) have been added the mixture is first heated to about 100° C. under reflux and under agitation on a magnetic stirrer and stirred for a further 15 min. Mixture pH is −1. Thereafter, the heating output of the magnetic stirrer is gradually raised until the mixture is boiling. After about 5 min of boiling a clear reddish solution forms.

### EXAMPLE 3

In the example which follows, the acid-insoluble residue of the styrene catalyst is quantitatively determined. For this, 10 g of milled styrene catalyst (as described in Example 2) are weighed into a 600 ml glass beaker. After 50 ml of completely ion-free water (CIF water) and 100 ml of concentrated hydrochloric acid (HCl, conc.) have been added the mixture is heated to the boil under reflux and under agitation on a magnetic stirrer and stirred for a further 15 min. The insoluble residue is filtered off through a black ribbon filter, washed and then ignited at 900° C.

The supernatant solution separated off is analyzed by elemental analysis using Inductively-Coupled Plasma Optical Emission Spectrometry (ICP-OES). It transpires that all the elements of the styrene catalyst used are present in the supernatant solution in the original proportions of the styrene catalyst used, except for cerium.

The amount of insoluble residue separated off is determined by gravimetry and is equal, within the experimental error, to the cerium quantity as cerium dioxide (CeO₂) present in the styrene catalyst used.

### EXAMPLE 4

### Dissolving of Cerium Dioxide and Fractional Precipitation

A 5 g quantity of cerium dioxide (of the HSA type from Rhodia) and 2 g of iron powder are weighed into a glass beaker and then 80 ml of completely ion-free water (CIF water) (devolatilized) and 10 ml of concentrated hydrochloric acid (HCl, conc.) are added. The mixture is heated on a magnetic stirrer until a clear solution forms. After the solution is cooled down to room temperature, the precipitation is commenced by adding saturated soda solution, while the pH of the solution is measured continuously. Starting with an initial pH of −0.7, saturated soda solution is carefully added dropwise using a pipette. Slight foaming up of the solution can be observed. At pH 2.5 iron compounds start to separate out in the form of a bluish green precipitate, while cerium compounds separate out from pH 6.5 in the form of a white precipitate. The addition of soda solution is continued until a pH of 7.5 is reached. The suspension formed is filtered off through a white ribbon filter and a porcelain nutsche. The residue is washed with about 200 ml of completely ion-free water (CIF water) and then dried in a drying cabinet at 100° C. for 3 hours.

The weight of the residue is found to be 9.78 g. A total of 51 g of saturated soda solution are consumed. Analysis of the residue gives the following results: Ce=38.1%, Fe=20.2%, CO₂=14.1%. The proportion of cerium and iron is determined using Inductively-Coupled Plasma Optical Emission Spectrometry (ICP-OES). The proportion of carbonate is determined gravimetrically. For this, the dried residue is placed in a round flask connected to at least one absorption tube and is admixed with concentrated sulfuric acid. The carbon dioxide gas formed is driven out with a purified stream of air and introduced into the absorption tube packed with supported sodium hydroxide. The weight increase of the absorption tube and from that the carbonate content are determined by gravimetry.

### EXAMPLE 5

### Dissolving of Styrene Catalyst and Fractional Precipitation

A 5 g quantity of pulverulent styrene catalyst (description see Example 2) and 0.2 g of iron powder are weighed into a glass beaker. Then, 80 ml of completely ion-free water (CIF water) (devolatilized) and 20 ml of concentrated hydrochloric acid (HCl, conc.) are added. The mixture is heated on a magnetic stirrer until a clear solution is formed. After the solution has cooled down to room temperature, the precipitation is commenced by addition of saturated soda solution, while the pH of the solution is measured continuously. Starting with an initial pH of −0.8 a saturated soda solution is carefully added dropwise using a pipette.

Slight foaming up of the solution can be observed. At pH 2.5 a precipitate starts to form; at about pH 6-7 the suspension undergoes distinct thickening. The addition of soda solution is continued until pH 7.5. The suspension formed is filtered off through a white ribbon filter and a porcelain nutsche.

The weight of the residue is found to be 6.28 g. A total of 77 g of saturated soda solution are consumed. Analysis of the residue gives the following results: Ce=6.3 wt %; Fe=49.2 wt %; CO₂=5.3 wt %. The residue additionally comprises further metals and/or compounds thereof which are present in the styrene catalyst used.

The proportion of iron is determined using atomic absorption spectrometry (AAS). The proportion of cerium and of the metal oxides mentioned is determined using Inductively-Coupled Plasma Optical Emission Spectrometry (ICP-OES). The proportion of carbonate is determined gravimetrically as described in Example 5.

### EXAMPLE 6

### Precipitation by Addition of Aqueous Sodium Hydroxide Solution

A 5 g quantity of cerium dioxide (of the HSA type from Rhodia) and 2 g of iron powder are weighed into a glass beaker and then admixed with 80 ml of completely ion-free water (CIF water) and 20 ml of concentrated hydrochloric acid (HCl, conc.). The mixture is heated on a magnetic stirrer under reflux until a clear yellow solution has formed. Solution pH is −0.3. After the solution has cooled down to room temperature, the precipitation by addition of concentrated aqueous sodium hydroxide solution is commenced. Concentrated aqueous sodium hydroxide solution is added dropwise while the solution pH is measured continuously. At about pH 2.5 a bluish green precipitate comprising iron can be observed. The suspension formed is filtered off through a white ribbon filter and a porcelain nutsche. Aqueous sodium hydroxide solution is further added dropwise to the supernatant solution. At about pH 7 up to about pH 8.5 a white precipitate comprising cerium comes down. The suspension formed is filtered off through a white ribbon filter and a porcelain nutsche.

### EXAMPLE 7

### Preparing a Dehydrogenation Catalyst

The residue obtained as described in Example 5 is mixed with iron oxide powder (Fe₂O₃, hematite), calcium carbonate and water so that a CeO₂ content of about 49 wt % is obtained. The mixture is placed in a muller. After addition of further dopants the mass is mullered for about 1 h. During mullering, plastification aids are added for the later extrusion. The mullered mass is subsequently extruded into 3 mm extrudates. The extrudates thus obtained are initially predried at 300° C. for 3 h and finally calcined at 900° C. for 1 h. The final reddish brown extrudates are shown by elemental analysis to comprise almost 10% of CeO₂ and about 12% of K₂O.

1-15. (canceled)

16. A process for preparing cerium(III) compounds which comprises the steps of
a) contacting a starting composition A comprising cerium dioxide and at least one further metal oxide selected from the group consisting of iron oxide, silicon dioxide, molybdenum oxide, lanthanum oxide, magnesium oxide and calcium oxide with at least one acid S and at least one iron component E comprising iron in the oxidation state 0 and/or II at a temperature ranging from 40 to 160° C. and at a pH of not more than 2 to obtain a solution L comprising cerium in the oxidation state III;
b) adding at least one basic compound C to said solution L to obtain a solid F comprising at least one cerium(III) compound;
c) separating off said solid F comprising at least one cerium(III) compound.

17. The process according to claim 16, wherein said starting composition A comprises a solid comprising cerium dioxide, at least one iron oxide and at least one alkali metal oxide.

18. The process according to claim 16, wherein said starting composition A comprises an aqueous suspension comprising cerium dioxide and silicon dioxide.

19. The process according to claim 16, wherein the at least one acid S is hydrochloric acid and/or sulfuric acid.

20. The process according to claim 16, wherein the at least one iron component E is selected from the group consisting of elemental iron, iron alloy, steel, steel alloy, iron(II) chloride, iron(II) carbonate, iron(II) sulfate and iron(II) ammoniumsulfate.

21. The process according to claim 16, wherein the at least one basic compound C is selected from the group consisting of alkali metal carbonate, alkali metal bicarbonate, alkaline earth metal carbonate, alkaline earth metal bicarbonate, alkali metal hydroxide and alkaline earth metal hydroxide.

22. The process according to claim 16, wherein said starting composition A is contacted with at least one acid S at temperatures ranging from 0 to 100° C. before step a and the solution obtained is separated off.

23. The process according to claim 16, wherein the adding of at least one basic compound C in step b provides a pH ranging from 6 to 12.

24. The process according to claim 16, wherein step b comprises the steps of:
adding at least one basic compound C to said solution L until a pH ranging from 2.5 to 5 is obtained to obtain a solid F2 comprising at least one iron compound;
separating said solid F2 from said solution L;
adding at least one basic compound C to said solution L until a pH ranging from 6 to 12 is obtained to obtain a solid F comprising at least one cerium(III) compound.

25. The process according to claim 16, wherein said solid F obtained in step c as comprising at least one cerium(III) compound is subjected to washing and/or drying.

26. A process for preparing a dehydrogenation catalyst comprising at least one iron oxide and at least one cerium(IV) compound, said process comprising preparing the cerium(III) compound according to claim 16 and also the steps of:
d) mixing said solid F comprising at least one cerium(III) compound with at least one further component and optionally water to obtain a catalyst composition K;
e) molding said catalyst composition K;
f) calcining said catalyst composition K to obtain a dehydrogenation catalyst comprising at least one iron oxide and at least one cerium(IV) compound.

27. The process for preparing a dehydrogenation catalyst according to claim 26 comprising the steps of:
a) contacting a starting composition A comprising cerium dioxide and at least one iron oxide with at least one acid S and at least one iron component E comprising iron in the oxidation state 0 and/or II at a temperature ranging from 40 to 160° C. and a pH of not more than 2 to obtain a solution L comprising cerium in the oxidation state III;
b) adding at least one basic compound C to said solution L to obtain a solid F comprising at least one cerium(III) compound and at least one iron compound;
c) separating off said solid F;
d) mixing said solid F with at least one further component selected from potassium oxide, iron oxide, magnesium oxide, calcium oxide, molybdenum oxide, potassium molybdate, tungsten oxide, potassium tungstenate, manganese dioxide, cobalt oxide, chromium oxide, copper oxide, nickel oxide, titanium dioxide, silicon dioxide, aluminum oxide, sodium oxide, zinc oxide, tin dioxide, silver oxide and rhenium oxide and optionally water to obtain a catalyst composition K;
e) molding said catalyst composition K;
f) calcining said catalyst composition K to obtain a dehydrogenation catalyst comprising at least one iron oxide and at least one cerium(IV) compound.

28. A composition comprising at least 20 wt % based on the entire composition of at least one cerium(III) compound; from 0 to 80 wt % based on the total weight of the rare earth metal oxides of at least one iron compound; and from 0 to 50 ppm based on the entire composition of nitrate.

29. The composition according to claim 28, comprising from 30 to 80 wt % based on the total weight of the rare earth metal oxides of at least one iron compound.

30. A process for preparing a dehydrogenation catalyst comprising at least one iron oxide and at least one cerium(IV) compound which comprises utilizing the cerium(III) compound obtainable by a process according to claim 16.
